(19) United States
(12) Patent Application Publication
(10) Pub. No.: US 2026/0194905 A1
(43) Pub. Date: Jul. 9, 2026

(54) METHOD FOR PATH PLANNING OF DRIVING ROBOT BY USING FEATURE MAP, AND COMPUTER-READABLE RECORDING MEDIUM IN WHICH PROGRAM FOR PERFORMING SAME METHOD IS RECORDED

(71) Applicant: BEMROBOTICS Inc., Busan (KR)

(72) Inventors: Jung Min KIM, Busan (KR); Jeong Min HEO, Busan (KR); Ui Gyo KIM, Busan (KR)

(73) Assignee: BEMROBOTICS Inc., Busan (KR)

(21) Appl. No.: 19/132,784

(22) PCT Filed: Nov. 22, 2023
(86) PCT No.: PCT/KR2023/018851

§ 371 Date: May 23, 2025

(30) Foreign Application Priority Data
Nov. 24, 2022 (KR) 10-2022-0159156

(51) Int. Cl. G05D 1/246

(52) U.S. Cl. CPC G05D 1/2462; G05D 1/2469

(57) ABSTRACT

A method for path planning of a driving robot by using a feature map, includes: a feature map generation step of generating a feature map including multiple nodes and multiple blocks on the basis of a topological map for a random space; a primary block search step of acquiring a departure node and an arrival node from among the multiple nodes, and designating a departure block and an arrival block on the basis of the departure node and the arrival node; a secondary block search step for determining the drivability of each of multiple subsequent blocks placed after the departure block, and performing path designation; and a termination step of terminating path planning if a random subsequent block is the arrival block.

### CROSS-REFERENCE TO PRIOR APPLICATIONS

This application is a National Stage Patent Application of PCT International Application No. PCT/KR2023/018851 (filed on Nov. 22, 2023), which claims priority to Korean Patent Application No. 10-2022-0159156 (filed on Nov. 24, 2022), which are all hereby incorporated by reference in their entirety.

### BACKGROUND

The present disclosure relates to a method for path planning of a driving robot using a feature map and a computer-readable recording medium in which a program for performing the same is recorded, and relates to a path planning technology for autonomous driving of a driving robot.

In driving of a robot, a map is created as a general method of expressing a surrounding environment, and such a map includes a grid map and a topological map. The grid map represents a space based on an absolute geometric location of an object by expressing a surrounding environment as an evenly spaced grid. That is, each grid indicates whether an obstacle is present within an area corresponding thereto. On the contrary, the topological map, which is a more abstract expression method compared to the grid map, expresses only relationships between features of the surrounding environment without introducing any absolute reference coordinates. Therefore, the topological map may be obtained as a concise map by expressing it as a graph consisting of nodes and arcs.

The grid map has an advantage of reducing uncertainty of a sensor and allowing relatively accurate modeling of the surrounding environment, but requires a lot of memory and computational power because an amount of data increases significantly depending on its resolution, and takes a lot of time to perform a certain function.

The topological map is simplified to only show important information and remove unnecessary details, and simplicity is its greatest advantage. The topological map enables rapid planning and provides a more natural interface, but with the recent emergence of the 4th industrial revolution, Kiva system, and untact technology, when hundreds to thousands of driving robots need to be controlled, topological maps also have technical limitations in that they require a large amount of data and complex and large computational processing.

Therefore, in the field of robot driving technology, there is an urgent need for surrounding environment expression technology to easily control hundreds to thousands of driving robots and path planning technology for each driving robot using this technology.

### SUMMARY

The present disclosure is intended to solve the foregoing problems, and an aspect of the present disclosure is to obtain a method for path planning of a driving robot using a feature map, which performs path planning of the driving robot using a feature map including multiple nodes and multiple blocks, so as to significantly shorten an optimization convergence time of the path planning and minimize an amount of computation of the path planning, and a computer-readable recording medium in which a program for performing the same is recorded.

Technical problems to be solved in the present disclosure are not limited to the above-mentioned problems and other technical problems which are not mentioned herein will definitely be understood by those skilled in the art from the following description.

In order to achieve the foregoing objectives, a method for path planning of a driving robot using a feature map may include a feature map generation step of generating, by at least one processor, a feature map including multiple nodes and multiple blocks on the basis of a topological map for a random space; a primary block search step of acquiring, by the at least one processor, a departure node and an arrival node from among the multiple nodes, and designating a departure block and an arrival block on the basis of the departure node and the arrival node; a secondary block search step of determining, by the at least one processor, the drivability of each of multiple subsequent blocks placed after the departure block to be designated as a path; and an end step of ending, by the at least one processor, path planning if a random subsequent block is the arrival block.

In order to achieve the foregoing objectives, the present disclosure provides a method for path planning of a driving robot using a feature map and a computer-readable recording medium in which a program for performing the same is recorded.

As described above, according to the present disclosure, path planning of a driving robot may be performed by using a feature map including multiple nodes and multiple blocks, so as to significantly shorten an optimization convergence time, and process operation and safety algorithms in block units, thereby allowing an intuitive path planning and minimizing an amount of computation for the path planning.

The effects of the present disclosure are not limited to the above-mentioned effects, and other effects that are not mentioned herein will be clearly understood by those skilled in the art from the following detailed description and appended claims.

### BRIEF DESCRIPTION OF THE DRAWINGS

FIG. 1 is a flowchart of a method for path planning of a driving robot using a feature map of the present disclosure.

FIG. 2 is a detailed flowchart of a feature map generation step according to one embodiment of the present disclosure.

FIG. 3 is a diagram showing a conventional topological map.

FIG. 4 is a diagram showing a separation node in a feature map according to one embodiment of the present disclosure.

FIG. 5 is a diagram showing a terminal block in a feature map according to one embodiment of the present disclosure.

FIG. 6 is a diagram showing a bidirectional block in a feature map according to one embodiment of the present disclosure.

FIG. 7 is a diagram showing a unidirectional block in a feature map according to one embodiment of the present disclosure.

FIG. 8 is a detailed flowchart of a primary block search step according to one embodiment of the present disclosure.

FIGS. 9A and 9B are diagrams showing a case where a departure block is an arrival block, a case where the departure block has priority over the arrival block, and a case where the arrival block is a terminal block on a feature map according to one embodiment of the present disclosure.

FIGS. 10A and 10B are diagrams showing a case where there are two departure blocks on a feature map according to one embodiment of the present disclosure.

FIGS. 11A-11C are detailed flowcharts of a secondary block search step and an end step according to one embodiment of the present disclosure.

### DETAILED DESCRIPTION

Although the terms used herein are selected from generally known and used terms considering their functions in the present disclosure, the terms may be modified depending on intention of a person skilled in the art, practices, or the advent of new technology. Besides, in a specific case, terms may be arbitrarily chosen by the present applicant, and in this case, the meanings of those terms will be described in corresponding parts of the present disclosure in detail. Accordingly, the terms used herein should be understood not simply by the actual terms used but by the meaning lying within and the description disclosed herein.

Unless defined otherwise, the terms used herein including technological or scientific terms have the same meaning that is generally understood by those skilled in the art to which the present disclosure pertains. The terms used herein shall not be interpreted not only based on the definition of any dictionary but also the meaning that is used phase the field to which the invention pertains, and shall not be interpreted too ideally or formally unless clearly defined herein.

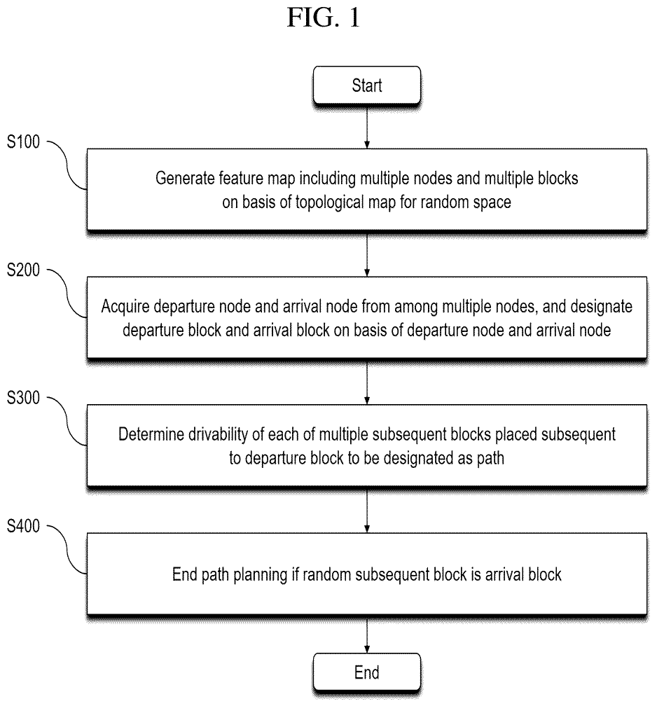

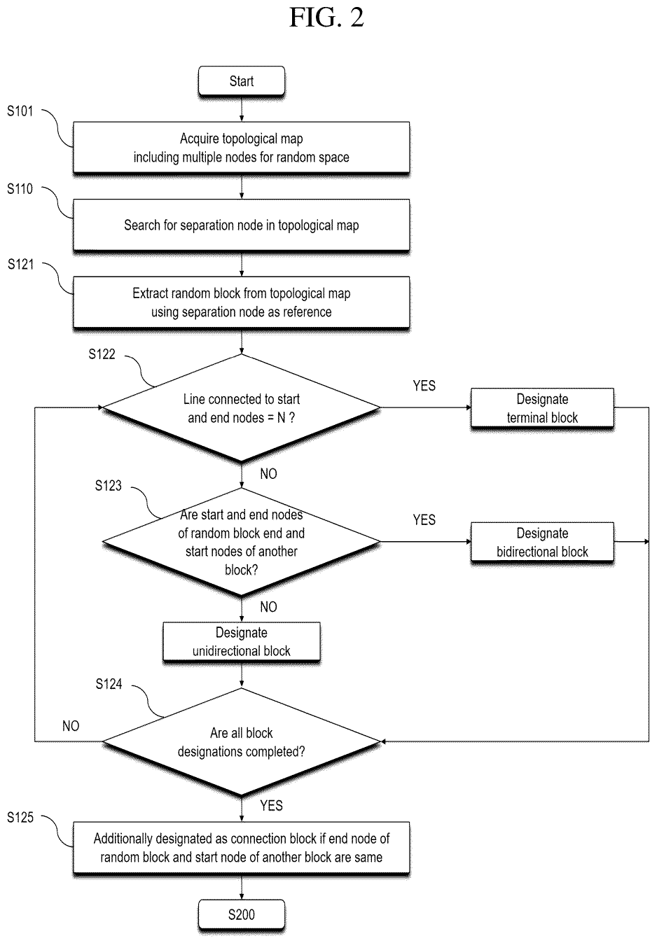

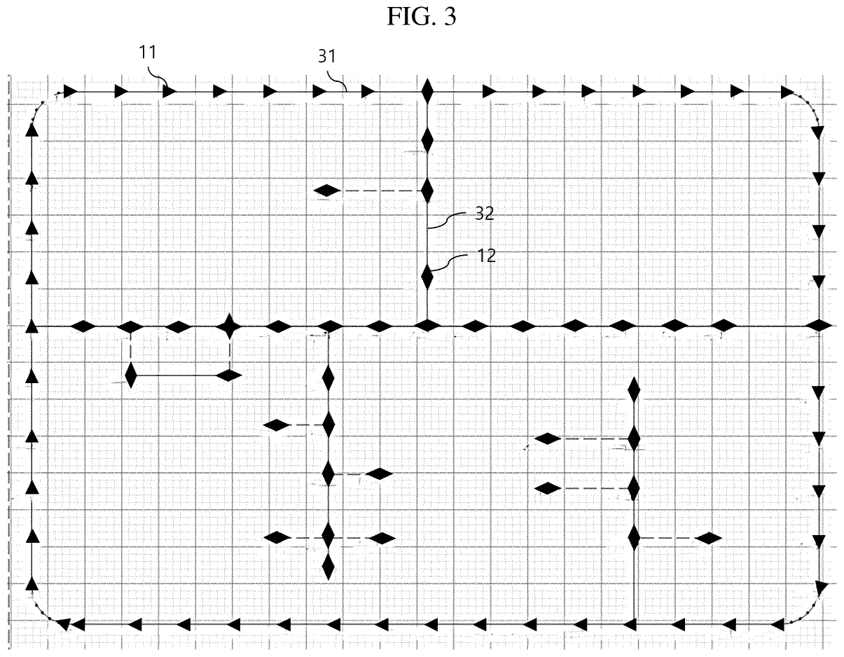

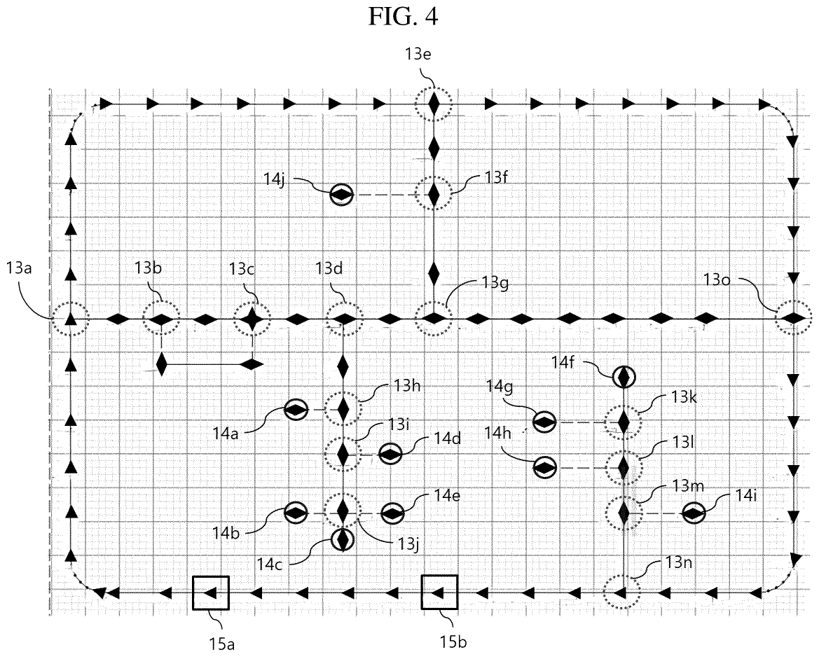

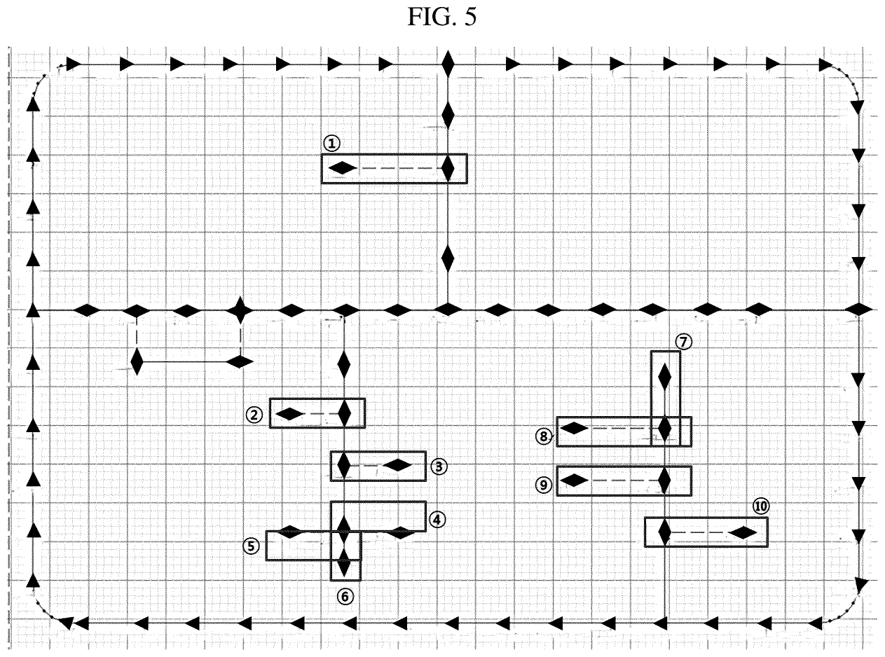

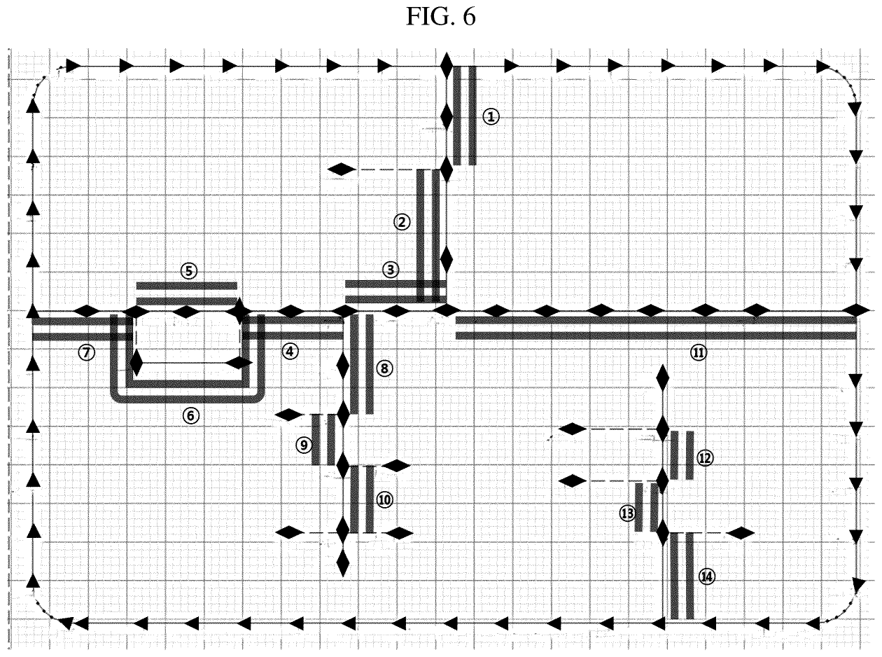

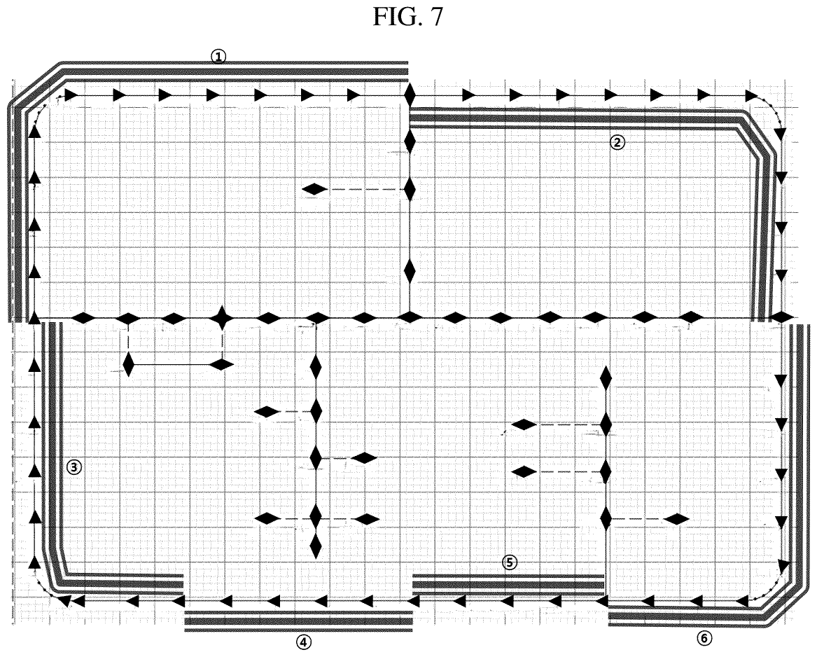

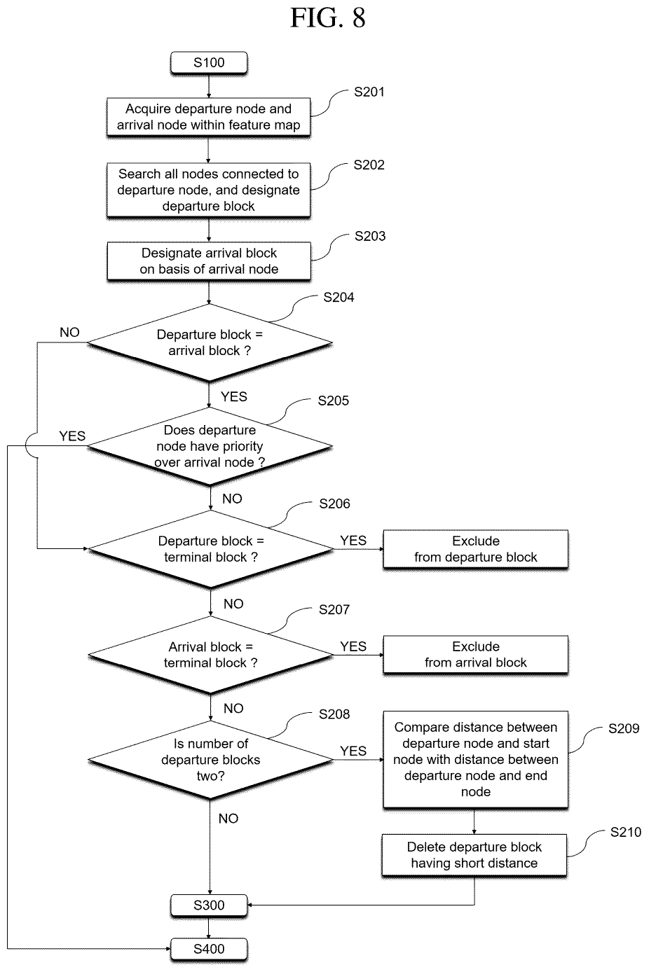

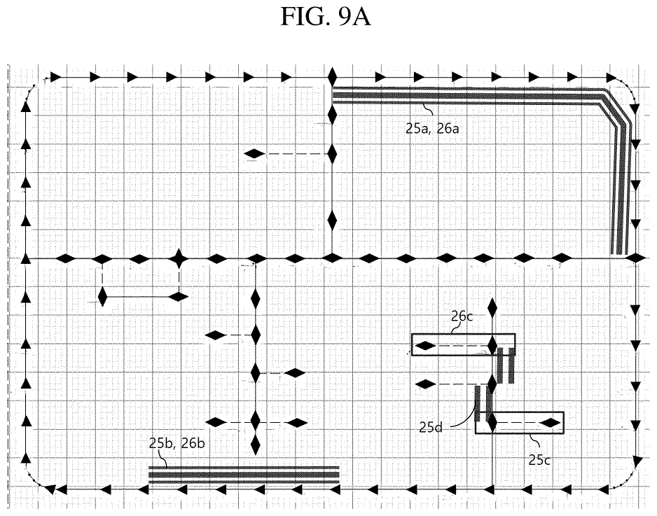

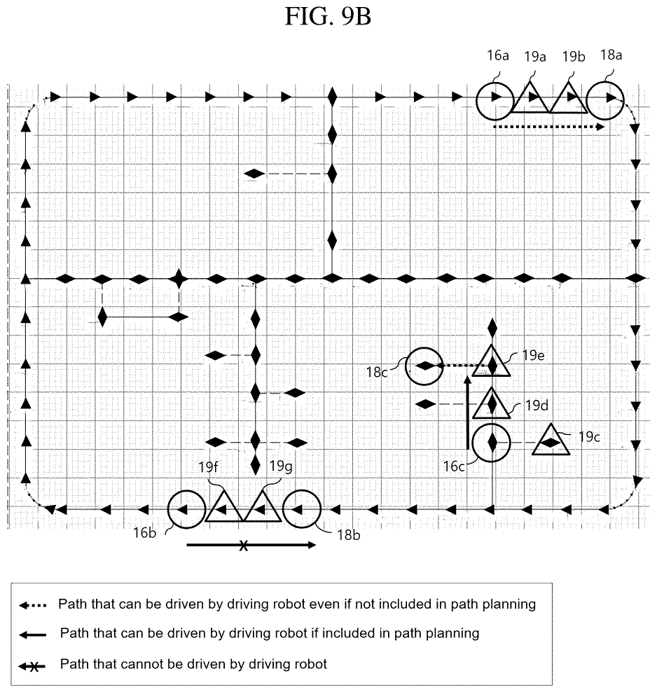

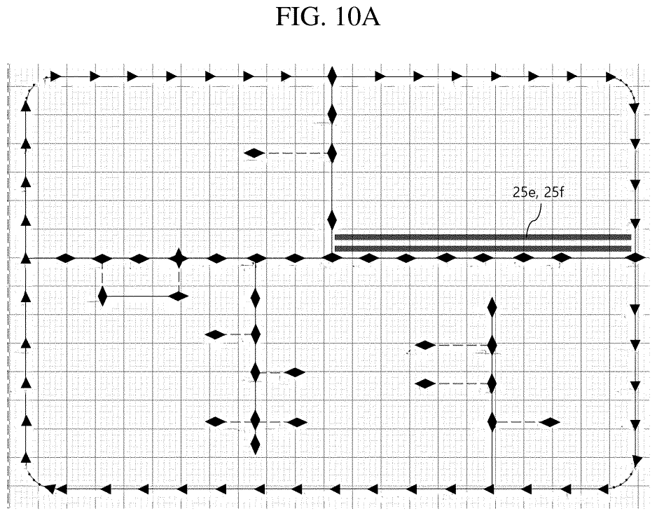

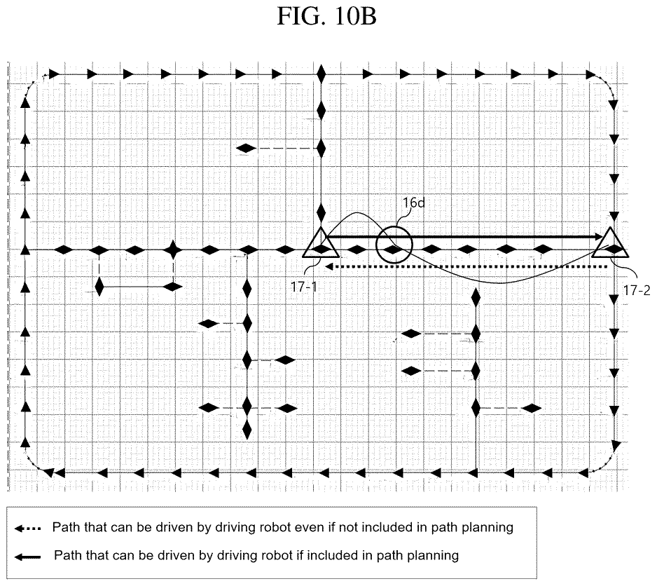

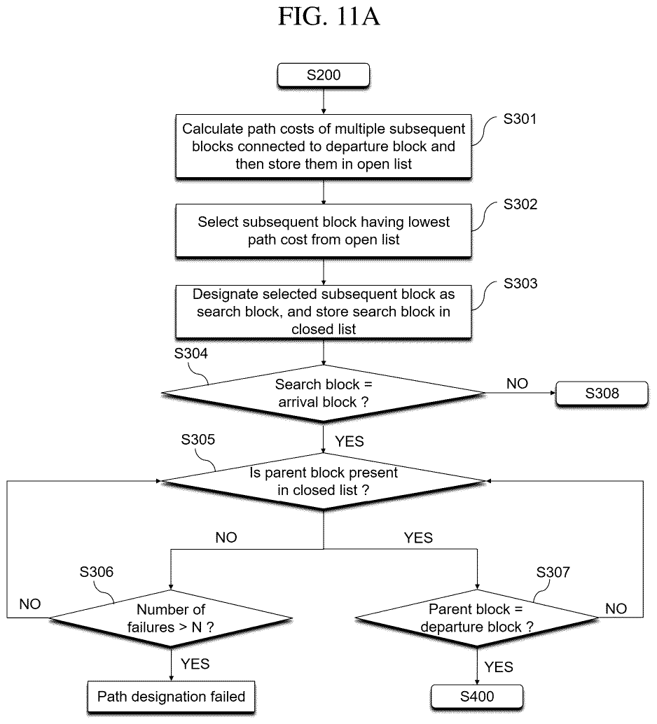

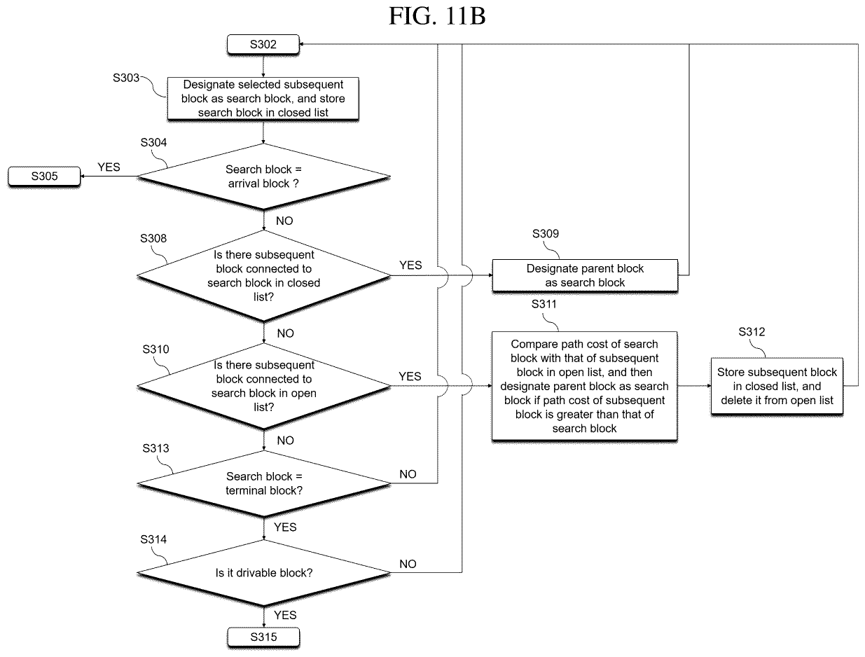

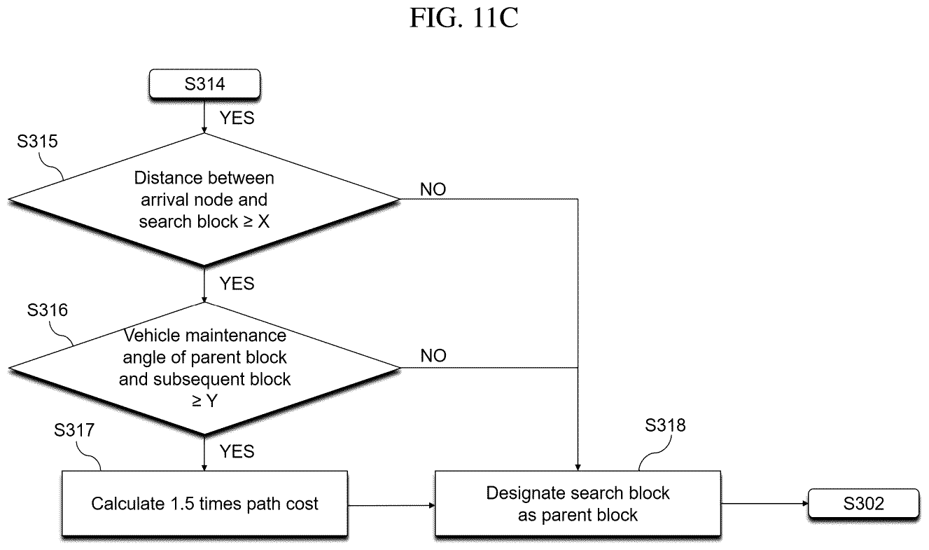

Hereinafter, an embodiment according to the present disclosure will be described in detail with reference to the accompanying drawings. FIG. 1 is a flowchart of a method for path planning of a driving robot using a feature map of the present disclosure. FIG. 2 is a detailed flowchart of a feature map generation step S100 according to one embodiment of the present disclosure. FIG. 3 is a diagram showing a conventional topological map. FIG. 4 is a diagram showing a separation node in a feature map according to one embodiment of the present disclosure. FIG. 5 is a diagram showing a terminal block 21 in a feature map according to one embodiment of the present disclosure. FIG. 6 is a diagram showing a bidirectional block 23 in a feature map according to one embodiment of the present disclosure. FIG. 7 is a diagram showing a unidirectional block 22 in a feature map according to one embodiment of the present disclosure. FIG. 8 is a detailed flowchart of a primary block search step S200 according to one embodiment of the present disclosure. FIGS. 9A and 9B are diagrams showing a case where a departure block 25a is an arrival block 26a, a case where the departure block 25a has priority over the arrival block 26a, and a case where the arrival block 26a is a terminal block 21 on a feature map according to one embodiment of the present disclosure. FIGS. 10A and 10B are diagrams showing a case where there are two departure blocks 25 on a feature map according to one embodiment of the present disclosure. FIGS. 11A-11C are detailed flowcharts of a secondary block search step S300 and an end step S400 according to one embodiment of the present disclosure.

First, the present disclosure includes a recording medium 120 that can be read by a computer device 100 in which a program for performing a method for path planning of a driving robot using a feature map is recorded. The recording medium 120, for example, may be a CD, a DVD, a hard disk, a Blu-ray disk, a USB, a memory card, a ROM, or the like. Furthermore, a method for generating a feature map of a driving robot of the present disclosure may be implemented by reading, by at least one processor 110 in the computer device 100, the recording medium 120.

In addition, a control system that controls multiple driving robots 200 within a random space may include a control server consisting of one or more computer devices 100. The control system may include multiple nodes 10, which are minimum units of execution processors for controlling multiple driving robots 200 in a random space. The control server may connect nodes, and transmit and receive data to and from the nodes.

In addition, the driving robot 200 of the present disclosure is a device that can determine a surrounding environment and drive autonomously to move from a current location to a destination location within a random space. That is, the driving robot 200 may include a moving unit 210 for moving, a sensor unit 220 for detecting a surrounding environment, such as a RiDar, a control unit 230 that processes information detected from the sensor unit 220, data transmitted from another driving robot, and data transmitted from a control server, and transmits an operation command or a stop command to the moving unit 210, a communication unit 240 that transmits and receives data to and from another driving robot and the control server, and a loading unit 250 that loads cargo according to the operation command of the control unit 230.

Furthermore, for autonomous driving of a driving robot in a random space, a mapping technology for a random space, a localization technology for estimating a current location of a driving robot on a map, a path planning technology for planning a path of a driving robot based on map information and current location information, and an obstacle avoidance technology for avoiding a collision between an obstacle and a driving robot during autonomous driving from a current location to a destination location are absolutely required. The present disclosure relates to a path planning technology that plans a path using a map that can significantly reduce an amount of computation for a large number of driving robots 200 within a random space on a control system.

Referring to FIG. 1, a method for path planning of a driving robot using a feature map of the present disclosure includes a feature map generation step S100, a primary block search step S200, a secondary block search step S300, and an end step S400.

More specifically, in the feature map generation step S100, a feature map including multiple nodes 10 and multiple blocks 20 is generated on the basis of a topological map for a random space by at least one processor 110.

First, the topological map mentioned in the present disclosure may include multiple nodes 10 and a driving path 30 connected to random two nodes. Referring to one embodiment of FIG. 3, multiple nodes 10 may be divided into unidirectional nodes 11 and bidirectional nodes 12 according to a direction thereof, and a driving path 30 may be divided into a unidirectional path 31 and a bidirectional path 32.

In addition, the feature map generation step S100 may include a separation node search step S110 of searching for a separation node in the topological map, and a block designation step S120 of extracting a random block from the topological map using the separation node as a reference, and designating a block type for the random block.

Referring to one embodiment of FIGS. 4 to 7, the separation node search step S110 may search for at least one of branch junction nodes 13a to 130 where a driving path joins or branches among multiple nodes 10, terminal nodes 14a to 14j located at a terminal of a driving path, and user-specified nodes 15a and 15b designated from a user terminal as the separation node.

That is, the separation node search step S110 may recognize multiple nodes 10 from the topological map, and divide the plurality of nodes 10 into separation nodes and non-separation nodes. The separation node search step S110 of the present disclosure has a remarkable effect of simplifying a topological map connected to multiple nodes and driving paths by dividing it into parts that are characteristic of the map, such as a joining or branching part, a terminal part, and a user-specified part.

Next, in the block designation step S120 may determine at least one of a number N of driving paths connected to a start node and an end node of the random block and whether the start node and the end node of the random block are included in another block. Here, N is a positive integer. Furthermore, the block designation step S120 may designate the random block as one of a terminal block 21, a unidirectional block 22, a bidirectional block 23, and a connection block 24.

A start node 17-1 and an end node 17-2 of a random block mentioned in the present disclosure are the separation nodes. A random block extracted from the block designation step S120 may be a block in which some of multiple nodes are extracted based on the separation node, wherein a random separation node may be used as a start node, another separation node may be used as an end node, and some other than the separation node may or may not be included between the start node and the end node.

Referring to one embodiment of FIG. 5, the block designation step S120 requires extracting a random block and then designating what kind of block the block is. The block designation step S120 may designate the block as a terminal block 21 if a number of driving paths connected to start and end nodes of a random block among multiple extracted random blocks is 1. That is, the terminal block 21 refers to a block to which the path is no longer connected.

Referring to one embodiment of FIG. 6, in the block designation step S120, if start and end nodes of a random block among multiple random blocks excluding the terminal block 21 are end and start nodes of another block, the block may be designated as a bidirectional block 23. That is, the bidirectional block 23 refers to a block consisting of a bidirectional path 32.

Referring to one embodiment of FIG. 7, in the block designation step S120, if start and end nodes of a random block among multiple random blocks excluding the terminal block 21 and the bidirectional block 23 are not end and start nodes of another block, the block may be designated as a unidirectional block 22. That is, the unidirectional block 22 refers to a block consisting of a unidirectional path 31.

Furthermore, in the block designation step S120, if the block types for all of the extracted multiple random blocks are designated, a connection block may be designated based on whether an end node of a random block and a start node of another block are the same among the extracted multiple random blocks.

In other words, the extracted multiple random blocks may be one of the terminal block 21, the unidirectional block 22, and the bidirectional block 23. Furthermore, they may also be repeatedly designated as connection blocks 24.

Therefore, a feature map mentioned in the present disclosure includes multiple blocks 20 based on a topological map, and each block may include one or more driving paths 30 connected to random two nodes.

According to the present disclosure, data within a conventional topological map may be separated and stored in block units, thereby having a remarkable effect of significantly reducing an amount of data and minimizing an amount of computation for a control system that controls a large number of driving robots.

Next, in the primary block search step S200, a departure node 16 and an arrival node 18 are acquired from among multiple nodes 10, and a departure block 25 and an arrival block 26 are designated on the basis of the departure node 16 and the arrival node 18 by the at least one processor 110.

The departure node 16 mentioned in the present disclosure is a departure point of path planning, and the arrival node 18 is an arrival point of path planning.

Referring to one embodiment of FIG. 8, in the primary block search step S200, a departure node 16 and an arrival node 18 within the feature map may be acquired (S201). In the primary block search step S200, all nodes connected to the departure node 16 are searched, and a departure block 25 including the departure node 16 and the search node 19 may be designated (S202). In this case, since there may be multiple search nodes 19, there may also be multiple departure blocks 25. In addition, the primary block search step S200 may designate an arrival block 26 on the basis of the arrival node 18 (S203).

In this case, in the primary block search step S200, it may be confirmed whether the departure block 25 and the arrival block 26 are the same block (S204). If the departure block 25 and the arrival block 26 are the same block, in the primary block search step S200, it may be confirmed whether the departure node 16 has priority over the arrival node 18 (S205). For example, referring to an upper right of FIG. 9A, it may be confirmed that the departure block 25a including the departure node 16a and the arrival block 26a including the arrival node 18a are the same, and that the departure node 16a has priority over the arrival node 18a depending on the directionality of the block. In contrast, referring to a lower left of FIG. 9B, the departure block 25b and the arrival block 26b are unidirectional blocks 22, and the arrival node 18b has priority over the departure node 16b, which violates the directionality of the block.

In the primary block search step S200 of the present disclosure, when the directionality of the block is violated, additional path planning may be carried out to establish path planning. On the contrary, when it matches the directionality of the block, the driving robot 200 may drive according to the directionality of the block without having to establishing it separately, so the ending step S400 may be carried out immediately. That is, the present disclosure has a remarkable effect of reducing an unnecessary amount of computation by planning the path of the driving robot 200 using the feature map.

In addition, if the departure block 25 and the arrival block 26 are different blocks, or if the departure block 25 and the arrival block 26 are the same but the departure node 16 does not have priority over the arrival node 18, in the primary block search step S200, it may be confirmed whether the departure block 25 and the arrival block 26 are terminal blocks 21 (S206, S207). The terminal block 21 is a block located at a terminal of the driving path, and is connected to another block through one path. Therefore, the driving robot 200 may drive even without separately establishing path planning including the terminal block 21. That is, the present disclosure may significantly reduce an amount of computation by not including the terminal block 21 in path planning. For example, as shown in FIGS. 9A and 9B, the departure nodes 16c may be included in the departure block 25c of the terminal block 21 and the departure block 25d of the bidirectional block 23, respectively. The arrival node 18c may be included in an arrival block 26c of the terminal block 21. In this case, in the primary block search step S200, the departure block 25c of the terminal block 21 may be excluded, and the arrival block 26c of the terminal block 21 may be excluded from among the two departure blocks 25c, 25d. Therefore, in the primary block search step S200, the terminal block 21 may be excluded from the departure block 25 so as not to allow to unnecessarily include a disconnected path in the path planning, thereby having a remarkable effect that the driving robot 200 can drive based on a different departure block 25d rather than the departure block 25c of the terminal block 21. Furthermore, the terminal block 21 may be excluded from the arrival block 26 so as to allow the terminal block 21 to be connected to another block through one path, and thus even if the arrival block 26c of the terminal block 21 is not included in the path planning, the driving robot 200 may drive to the arrival node 16c, which has a remarkable effect of not having to establish unnecessary path planning.

In addition, in order to minimize an amount of computation, in the primary block search step S200, when there are the two departure blocks 25, a distance between the departure node 16 and the start node 17-1 and a distance between the departure node 16 and the end node 17-2 are compared to delete a random departure block 25.

Referring to one embodiment of FIGS. 10A and 10B, in the primary block search step S200, it may be confirmed that there are two departure blocks 25 since they are the bidirectional blocks 23. The bidirectional block 23 may include a departure block 25e having a forward node and a departure block 25f having a reverse node. In the forward departure block 25e, a node with the highest priority is the start node 17-1, and a node at the very end is the end node 17-2. Then, in the primary block search step S200, a distance from the departure node 16d to the start node 17-1 and a distance from the departure node 16d to the end node 17-2 may each be calculated by using an Euclidean distance measurement method based on two-dimensional coordinates.

In this case, in the primary block search step S200, if a shorter distance between the distance from the departure node 16d to the start node 17-1 and the distance from the departure node 16d to the end node 17-2 is subsequent to the path planning, the reverse departure block 25f corresponding thereto may be deleted from one embodiment of FIGS. 10A and 10B. That is, basically, in the case of the bidirectional block 23, two path plannings must be made each in forward and reverse directions to find an optimal path, but there is a technical limitation that an amount of computation increases. In order to solve this problem, in the primary block search step S200 of the present disclosure, it may be confirmed that the departure block 25e in a forward direction with a relatively long distance is set as a departure reference for path planning, and whether the departure block 25f in a reverse direction is present subsequent to the path planning, thereby allowing the driving robot 200 to automatically drive along an reverse path. That is, the driving robot 200 may drive from the start node 17-1 to the end node 17-2, and then drive again from the end node 17-2 to the start node 17-1.

Therefore, the primary block search step S200 has a remarkable effect of facilitating future path planning by accurately designating the departure block 25 and the arrival block 26, and reducing an overall amount of calculation by reducing unnecessary repetitive calculations.

Next, in the secondary block search step S300, the drivability of multiple subsequent blocks 27 placed subsequent to the departure block 25 is each determined and designated as a path by the at least one processor 110. Next, the end step S400 ends path planning by the at least one processor 110 if a random subsequent block is an arrival block.

Referring to one embodiment of FIGS. 11A-11C, in the secondary block search step S300, path costs of multiple subsequent blocks 27a, 27b, 27c, 27d, 27e connected to the departure block 25 may be calculated and then stored in an open list (S301).

Here, the path costs may be a value obtained by adding up a distance along a driving path from the departure node 16 included in the departure block 25 calculated using an Euclidean distance measurement method to the end node 17-2 of each of multiple subsequent blocks 27a, 27b, 27c, 27d, 27e, and a straight-line distance from the end node 17-2 of each of the multiple subsequent blocks 27a, 27b, 27c, 27d, 27e calculated using the Euclidean distance measurement method to the arrival node 18.

Furthermore, in the secondary block search step S300, a subsequent block 27c having a lowest path cost C may be selected from an open list L_{Open} including multiple subsequent blocks 27a, 27b, 27c, 27d, 27e and a path cost A, B, C, D, E of each block (S302). Furthermore, in the secondary block search step S300, the selected subsequent block 27c is designated as a search block 28a, and multiple subsequent blocks 27a, 27b connected between the departure block 25 and the search block 28a may all be stored in a closed list L_{Close} (S303). In this case, the closed list L_{Close} may also store the path cost A, B, C of each stored block.

Furthermore, in the secondary block search step S300, it may be confirmed whether the search block 28a is the arrival block 26 (S304). If the search block 28a is the arrival block 26, it may be confirmed whether a parent block 29 is present in the closed list (S305). On the contrary, if the search block 28a is not the arrival block 26, it may be confirmed whether another subsequent block 27a, 27b connected to the search block 28a is present in the closed list L_{Close}, and/or it may be confirmed whether another subsequent block 27a, 27b, 27d, 27e connected to the search block 28a is present in the open list L_{Open}.

Here, the parent block 29 refers to a preceding block connected to the search block 28a. That is, the departure block 25 cannot have the parent block 29. Furthermore, there may be multiple parent blocks 29, which is the case when the preceding block is the bidirectional block 23.

First, if the search block 28a is the arrival block 26, in the secondary block search step S300, it may be confirmed whether the parent block 29 is present in the closed list L_{Close} (S305). If the parent block 29 is not present in the closed list L_{Close}, it may be repeatedly confirmed whether the parent block 29 is present, and if a number of failures exceeds N, it may be determined that path designation has failed, and thus the end step S400 may be carried out (S306). Here, N is a positive integer. On the contrary, if the parent block 29 is present in the closed list L_{Close}, it may be additionally confirmed whether the parent block 29 is the departure block 25 (S307).

If the parent block 29 is the departure block 25, in the secondary block search step S300, it may be confirmed whether there is a connected preceding block to confirm whether the specified path is a connected path without any breaks. If the parent block 29 is the departure block 25, it may be determined that path designation from the departure block 25 to the arrival block 26 is completed without any breaks, and thus the end step S400 may be carried out. On the contrary, if the parent block 29 is not the departure block 25, in the secondary block search step S300, it may be repeatedly confirmed whether the parent block 29 is present until the presence of the parent block 29 is not confirmed in the closed list L_{Close}.

Next, referring to one embodiment of FIGS. 11A-11C, if the search block 28a is not the arrival block 26, it may be confirmed whether there is another subsequent block connected to the search block 28a in the closed list L_{Close} (S308). If there is another subsequent block connected to the search block 28a in the closed list L_{Close}, the search block 28a may be designated as the parent block 29 in the closed list L_{Close} (S309). Furthermore, the subsequent block 27d having the next lowest path cost may be selected again in the open list L_{Open}. The selected subsequent block 27d may be designated as another search block 28b, and the another search block 28b may be stored in the closed list L_{Close}. If the another search block 28b is not the arrival block 26, it may be confirmed whether there is another subsequent block 27e connected to the another search block 28b in the closed list L_{Close}. If there is the another subsequent block 27e connected to the another search block 28b in the closed list L_{Close}, the parent block 29 may be designated as the another search block 28b in the closed list L_{Close}. This process may be repeated until the search block 28 becomes the arrival block 25.

On the contrary, if there is no other subsequent block connected to the search block 28a in the closed list L_{Close}, it may be confirmed whether there is another subsequent block 27d connected to the search block 28a in the open list L_{Open} (S310). If there is another subsequent block 27d connected to the search block 28a in the open list L_{Open}, in the secondary block search step S300, the path cost C of the search block 28a may be compared with the path cost D of another subsequent block 27d in the open list L_{Open}, and then if the path cost D of another subsequent block 27d is greater than the path cost C of the search block 28a, the parent block 29 may be designated as the search block 28a (S311). Furthermore, the another subsequent block 27d may be stored in the closed list L_{Close}, and may be deleted from the open list L_{Open} (S312). That is, the closed list L_{Close} may include a departure block 25, multiple subsequent blocks 27a, 27b, 27c, 27d, and a path cost of each block A, B, C, D. Furthermore, the open list L_{Open} may include a departure block 25 excluding another subsequent block 27d, multiple subsequent blocks 27a, 27b, 27c, 27e, and a path cost A, B, C, E of each block.

On the contrary, if there is no other subsequent block connected to the search block 28a in the closed list L_{Close} and the open list L_{Open}, in the secondary block search step S300, it may be confirmed whether the search block 28a is the terminal block 21 (S313). If the search block 28a is not the terminal block 21, in the secondary block search step S300, it may be returned to a process in which a subsequent block having a next lowest path cost is selected in the open list L_{Open}. This is because the secondary block search step S300 determines that path planning is not possible with a currently selected search block 28a to reselect another search block. On the contrary, if the search block 28a is the terminal block 21, it may be confirmed whether it is a drivable block (S314).

A drivable block mentioned in the present disclosure is a block excluding a non-drivable block that is set so as not to be manually driven through a user terminal prior to path planning being set. That is, in the secondary block search step S300, it may be confirmed that it is a drivable block if it is not set as a non-drivable block by the user terminal.

If the search block 28a is not a drivable block, in the secondary block search step S300, it may be returned to a process in which a subsequent block having a next lowest path cost is selected in the open list L_{Open}. This is also because the secondary block search step S300 determines that path planning is not possible with a currently selected search block 28a to reselect another search block.

Meanwhile, the secondary block search step S300 may preferentially designate a subsequent block with a high straightness as a path using an arrival node distance, which is a distance between the subsequent block for which the drivability has been determined and the arrival node 18, and a vehicle maintenance angle in the subsequent block for which the drivability has been determined. Here, the subsequent block may be the search block 28a.

In other words, in the secondary block search step S300, if the search block 28a is the terminal block 21 as well as the drivable block, and the arrival block 26 is the terminal block 21, a vehicle maintenance angle may be considered when an arrival node distance, which is a distance between the search block 28a and the arrival node 18, is above a preset distance X (S315). On the contrary, if it is below the preset distance X, the parent block 29 may be designated as the search block 28a, and then returned to select a subsequent block having a lowest path cost in the open list L_{Open}. Here, X may be a positive integer, most preferably 100 mm.

In addition, in the secondary block search step S300, if an arrival node distance, which is a distance between the search block 28a and the arrival node 18, is above a preset distance X, it may be confirmed that a vehicle maintenance angle of the parent block 29 and the search block 28a is a preset angle Y (S316). When the vehicle maintenance angle is above the preset angle Y, 1.5 times the calculated path cost may be calculated (S317). Furthermore, the search block 28a may be designated as the parent block 29, and may be stored in the open list L_{Open} along with the calculated path cost (S318). On the contrary, when it is below the preset angle Y, it is not calculated by 1.5 times, and the search block 28a may be designated as the parent block 29, and may be stored in the open list L_{Open} along with the calculated path cost. Here, Y may be a positive integer, and most preferably, it may be confirmed that an internal angle of the vehicle maintenance angle of the parent block 29 and the vehicle maintenance angle of the search block 28a are above 30 degrees.

That is, the present disclosure determines that an optimal path is designated by establishing path planning toward a side with a lowest path cost. Therefore, the path cost may be recalculated to be higher when the vehicle maintenance angle is high so as to allow a block with a high straightness to be searched first, thereby reducing the possibility of being designated as a path.

Therefore, according to the present disclosure, path planning of a driving robot may be performed by using a feature map including multiple nodes 10 and multiple blocks 20, so as to significantly shorten an optimization convergence time, and process operation and safety algorithms in block units, thereby having a remarkable effect of allowing an intuitive path planning and minimizing an amount of computation for the path planning.

In addition, the present disclosure has a remarkable effect capable of clearly designating the departure block 25 and the arrival block 26 by having the primary block search step S200. Furthermore, when the bidirectional block 23 is designated as the departure block 25, the departure block 25 may be designated based on a forward direction, which has a remarkable effect of reducing an amount of computation.

In addition, the present disclosure may be provided with the secondary block search step S200, and thus when it is confirmed whether the search block 28 is the arrival block 26, then parent blocks previously connected to the arrival block 26 are confirmed, and then the departure block 25 is finally confirmed, it may be determined that one connected path has been designated to end path planning. Furthermore, if the search block 28 is not the arrival block 26, other blocks 27 connected to the search block 28 may be confirmed in the closed list and the open list, and if parent blocks previously connected to the other blocks are confirmed, and the arrival block 26 and the departure block are confirmed from among the parent blocks, it may be determined that one connected path has been designated to end path planning. Finally, if the search block 28 is not the arrival block 26, and at the same time, no other blocks 27 connected to the search block 28 in the closed list and the open list are confirmed, it may be confirmed whether the search block 28 is the terminal block 21 and whether it is drivable, and if not, it may be determined that path planning cannot be performed through the search block 28 to select another subsequent block 27 from the open list. If the search block 28 is the terminal block 21, and it is drivable, a distance between the arrival node 18 and the search block 28 and a vehicle maintenance angle may be considered to recalculate the path cost, and there is a remarkable effect of allowing path planning to be performed ultimately toward a higher straightness.

Embodiments may be implemented by hardware, software, firmware, middleware, microcode, hardware description languages, or any combination thereof. When implemented in software, firmware, middleware, or microcode, the program code or code segments to perform necessary tasks may be stored in a computer-readable storage medium and executed by one or more processors.

Furthermore, aspects of the subject matter described herein may be described in the general context of computer-executable instructions, such as program modules or components that are executed by a computer. In general, program modules or components include routines, programs, objects, and data structures that perform specific tasks or implement specific data types. Aspects of the subject matter described herein may be practiced in distributed computing environments where tasks are performed by remote processing devices that are linked through a communications network. In a distributed computing environment, program modules may be located in both local and remote computer storage media including memory storage devices.

As described above, though the embodiments have been described with limited embodiments and drawings, those skilled in the art may make various modifications and variations from the above description. For example, although the above-described techniques are performed in a different order from that of the above-described method, and/or the above-described components, such as a system, a structure, a device, and circuit, are coupled or combined in a different form from that of the above-described method, or replaced or substituted with other components or equivalents, proper results may be achieved.

Therefore, other implementations, other embodiments, and equivalents to the claims are within the scope of the following claims.

1. A method for path planning of a driving robot using a feature map, the method comprising:
a feature map generation step of generating, by at least one processor, a feature map including multiple nodes and multiple blocks on the basis of a topological map for a random space;
a primary block search step of acquiring, by the at least one processor, a departure node and an arrival node from among the multiple nodes, and designating a departure block and an arrival block on the basis of the departure node and the arrival node;
a secondary block search step of determining, by the at least one processor, the drivability of each of multiple subsequent blocks placed after the departure block to be designated as a path; and
an end step of ending, by the at least one processor, path planning if a random subsequent block is the arrival block.

2. The method of claim 1, wherein the feature map generation step comprises:
a separation node search step of searching for a separation node in the topological map; and
a block designation step of extracting a random block from a topological map using the separation node as a reference, and designating a block type for the random block.

3. The method of claim 2, wherein the primary block search step compares, when there are two departure blocks, a distance between the departure node and a start node with a distance between the departure node and an end node to delete a random departure block so as to minimize an amount of computation.

4. The method of claim 1, wherein the secondary block search step preferentially designates a subsequent block with a high straightness as a path using an arrival node distance, which is a distance between the subsequent block for which the drivability has been determined and the arrival node, and a vehicle maintenance angle in the subsequent block for which the drivability has been determined.

5. A computer-readable recording medium in which a program for performing the method for path planning of a driving robot using a feature map of claim 1 is recorded.
